(19) United States
(12) Patent Application Publication
(10) Pub. No.: US 2011/0141519 A1
(43) Pub. Date: Jun. 16, 2011

(54) DATA PROCESSING SYSTEM, DATA PROCESSING APPARATUS, DATA PROCESSING METHOD, INFORMATION PROCESSING APPARATUS, INFORMATION PROCESSING METHOD, AND STORAGE MEDIUM

(75) Inventor: Hideki Hirose, Tokyo (JP)

(73) Assignee: CANON KABUSHIKI KAISHA, Tokyo (JP)

(21) Appl. No.: 12/966,376

(22) Filed: Dec. 13, 2010

(30) Foreign Application Priority Data
Dec. 15, 2009 (JP) 2009-284566

(51) Int. Cl. G06F 3/12; G06F 3/041

(52) U.S. Cl. 358/1.15; 345/173

(57) ABSTRACT

The present invention can intuitively perform processing such as printing relating to an application program that is opened by an information processing apparatus. Further, the present invention displays an image indicted by data, by a display unit of a data processing apparatus so that a user can easily confirm whether the data that is about to be processed by the data processing apparatus is the desired data.

### BACKGROUND OF THE INVENTION

1. Field of the Invention

The present invention relates to a data processing system, a data processing apparatus, a data processing method, an information processing apparatus, an information processing method, and a storage medium.

2. Description of the Related Art

When a user wishes to print data from an application program open on an information processing apparatus such as a personal computer (PC), the user confirms whether the data to be printed is the desired data. An example of a technique for the user to confirm this is to have the user specify the desired data and make the information processing apparatus display an image of the page specified by the user (e.g. Japanese Patent Application Laid-Open No. 2003-177905).

Further, when the user wishes to process data of the application program open on the information processing apparatus with a data processing apparatus, the user will want to confirm whether the data to be processed by the data processing apparatus is the desired data. For example, before the data processing apparatus processes that data, the user will want to preview an image that shows the data on a display unit of the data processing apparatus.

However, if the data processing apparatus receives the application program data from the information processing apparatus, and processes that data from the top page, unnecessary data processing is performed. Further, if the data processing apparatus receives the application program data from the information processing apparatus, and displays an image showing that data from the top page, it is difficult for the user to confirm whether that data is the desired data or not. For the user, displaying an image of the same page as the page opened by the application program allows the user to more easily determine whether that data is the desired data.

### SUMMARY OF THE INVENTION

According to an aspect of the present invention, a data processing apparatus, capable of communicating with an information processing apparatus, comprises a receiving unit configured to receive data of an application program that is running on the information processing apparatus, and a page number of a page that is opened by the application program from the information processing apparatus, a display unit configured to display an image of a page corresponding to the page number received by the receiving unit from among the data received by the receiving unit, and a data processing unit configured to, after the image is displayed by the display unit, process data received by the receiving unit. According to an aspect of the present invention, an information processing apparatus, capable of communicating with a data processing apparatus, comprises a first specifying unit configured to specify an application program running on the information processing apparatus, a second specifying unit configured to specify a page that is opened by the application program from among data of the application program running on the information processing apparatus, and a sending unit configured to send to the data processing apparatus data corresponding to the page specified by the second specifying unit from among the data of the application program specified by the first specifying unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a data processing system that can apply the present invention.

FIG. 2 is a block diagram illustrating a configuration of a data processing apparatus 100 and an information processing apparatus 150.

FIG. 3 is a block diagram illustrating a functional configuration of the information processing apparatus 150.

FIG. 4 is a flowchart illustrating information processing executed by the information processing apparatus 150.

FIG. 5 is a sequence diagram illustrating negotiation for establishing a communication connection by wireless communication between the information processing apparatus 150 and the data processing apparatus 100.

FIGS. 6A, 6B, and 6C illustrate an example of a screen displayed by a display unit 253 of the information processing apparatus 150.

FIG. 7 is a flowchart illustrating data processing executed by the data processing apparatus 100.

FIG. 8 illustrates an example of a preview image displayed on a display unit 202.

FIG. 9 illustrates an example of a screen for specifying a page.

FIGS. 10A and 10B illustrate a preview image of the previous and next pages.

FIG. 11 illustrates an example of a screen for specifying a final page.

### DESCRIPTION OF THE EMBODIMENTS

Various exemplary embodiments, features, and aspects of the invention will be described in detail below with reference to the drawings.

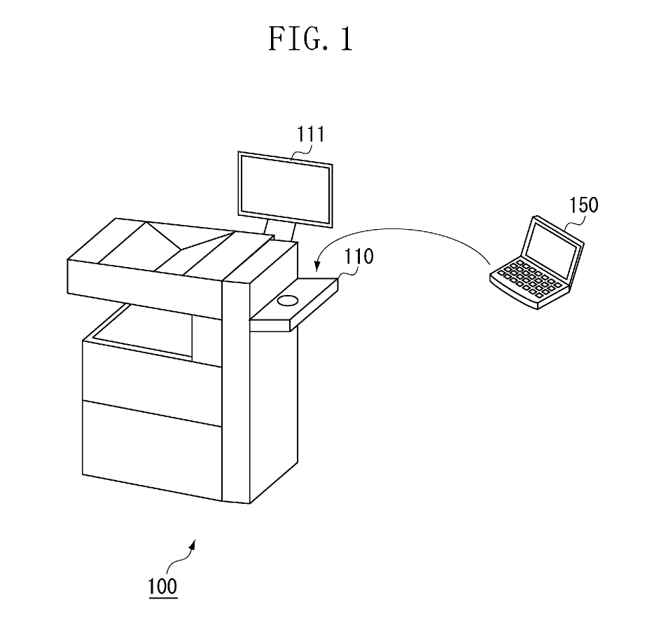

FIG. 1 illustrates a configuration of a data processing system to which the present invention can be applied. In FIG. 1, a multifunction peripheral (MFP) that includes a plurality of functions is illustrated as an example of a data processing apparatus, and a laptop PC is illustrated as an example of an information processing apparatus capable of communication with the data processing apparatus.

Recently, many workplaces have introduced a “free seating” type office, in which individuals do not have a fixed seating position, but use any available free seat. The merits of this type of office are that a person can only hold the minimum required amount of materials as they cannot keep materials at their own desk, and that space can be saved.

Each person is given a laptop PC, and paper materials are computerized as much as possible. Accordingly, each person can access the computerized materials from any seat via a network.

On the other hand, in this type of office, since the user's seat is not fixed, the data processing apparatus used by the user is also not fixed. When the user wishes to print a material, it is desirable that the user can simply perform the printing operation just by placing his/her laptop PC at a predetermined location for the printer. Especially, when printing data that is currently used by an application program open on the laptop PC, it is desirable that the user can print the data by a very intuitive operation.

Accordingly, an example will now be described in which the data processing apparatus processes data from an application program just by the user placing the information processing apparatus at a predetermined location to the data processing apparatus.

The data processing apparatus 100 includes a communication unit 110 and an operation unit 111. The communication unit 110 is for communicating with an external apparatus, such as a digital camera, mobile phone, and a laptop PC. Similar to the data processing apparatus 100, the information processing apparatus 150 also includes a communication unit (not illustrated). Communication between the data processing apparatus 100 and the information processing apparatus 150 may be performed by wireless communication or by wired communication. However, in the present exemplary embodiment, an example of wireless communication which enables intuitive connection for the user will be described.

Communication between the data processing apparatus 100 and the information processing apparatus 150 is enabled by the user holding the information processing apparatus 150 in his/her hands and approaching the communication unit 110.

The operation unit 111 is configured from a touch panel and keys. The operation unit 111 displays an operation screen, and receives instructions from the user. Further, the operation unit 111 also displays a status screen that shows the state of the data processing apparatus 100, and a preview screen for previewing an image that shows the image data.

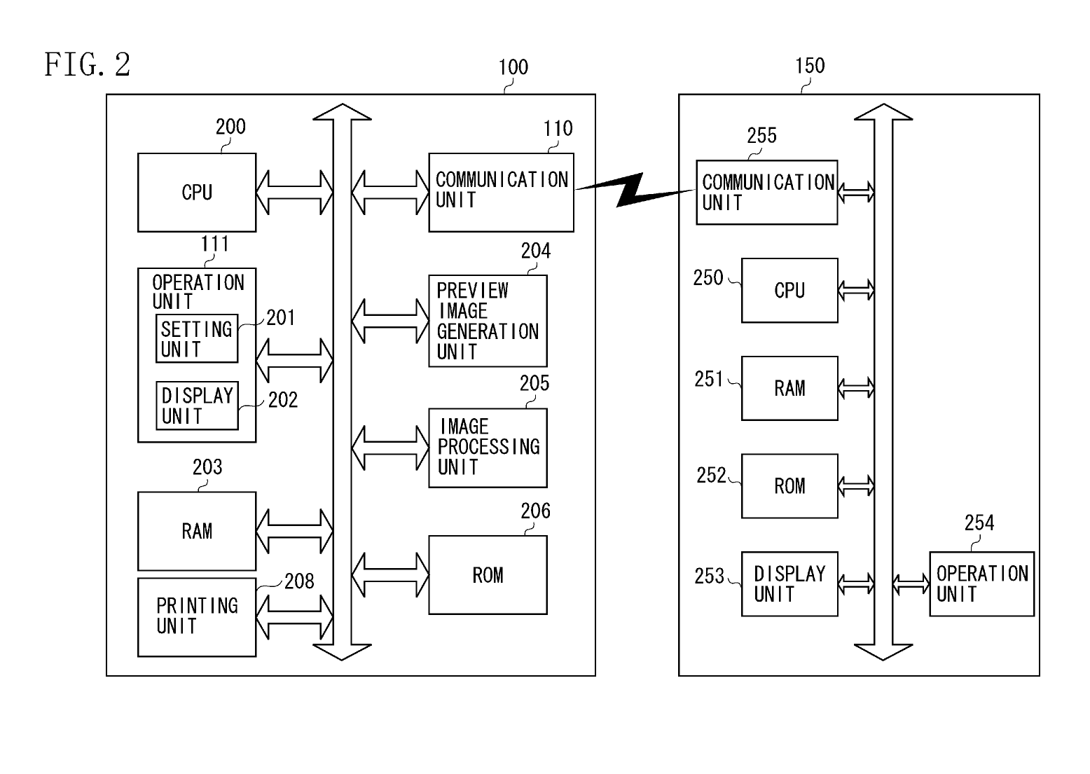

FIG. 2 is a block diagram illustrating a configuration of the data processing apparatus 100 and the information processing apparatus 150. FIG. 2 mainly illustrates the configuration of a controller in the data processing apparatus 100. Based on the functions of the data processing apparatus 100, the data processing apparatus 100 includes units such as a reading control unit and a scanner engine. However, a description of these units will be omitted here.

A central processing unit (CPU) 200 controls operation of the data processing apparatus 100 based on a program read from a read-only memory (ROM) 206. For example, the CPU 200 controls operation of the data processing apparatus 100 to write data into a storage unit, such as a random access memory (RAM) 203 and a hard disk drive (HDD) (not illustrated), and to read data from the storage unit based on the read program.

The operation unit 111 is configured from a setting unit 201 and a display unit 202. The setting unit 201 is configured from hard keys and a liquid crystal touch panel. The setting unit 201 receives key inputs from the user. The display unit 202 is a liquid crystal panel or the like. The display unit 202 displays various operation screens, and a preview image generated by a preview image generation unit 204. A setting unit 201 and the display unit 202 may be provided as a single integrated liquid crystal touch panel, or may be provided separately.

The RAM 203 is used as a work area of the CPU 200 and as an area for storing image data.

The communication unit 110 detects that information processing apparatus 150 has approached, and transmits control data and image data to the information processing apparatus 150.

The preview image generation unit 204 generates preview image data based on the image data received from the information processing apparatus 150. The method for generating the preview image data will be described below. An image processing unit 205 performs image processing on image data received from a scanner engine (not illustrated) and on the data to be printed. A printing unit 208 prints an image based on the image data generated by the image processing unit 205.

A communication medium 207 is a close range wireless communication medium. However, the communication medium 207 may also be a wired communication medium, such as a universal serial bus (USB) or a local area network (LAN).

A CPU 250 controls operation of the information processing apparatus 150 based on a program read from a ROM 252. For example, the CPU 250 controls operation of the information processing apparatus 150 to write data into a storage unit, such as a RAM 251 and a hard disk drive (HDD) (not illustrated), and to read data from the storage unit based on the read program. The RAM 251 is used as a work area of the CPU 250 and as an area for storing image data.

A display unit 253 is a display device or the like, which displays various application program screens. An operation unit 254 is a device such as a keyboard or a mouse, which receives key inputs from the user. A communication unit 225 transmits and receives control data and image data with the data processing apparatus 100.

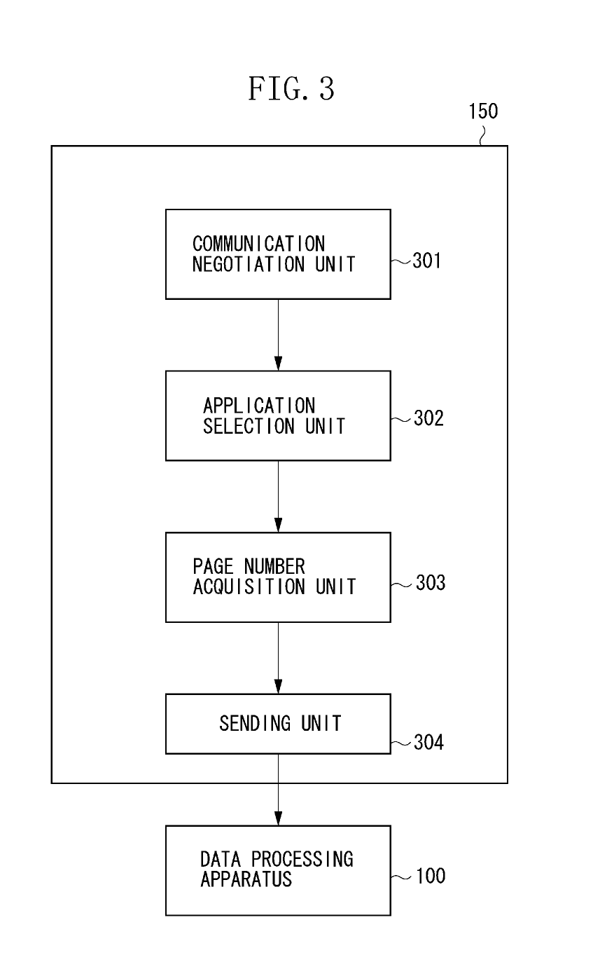

FIG. 3 is a function block diagram illustrating the functional configuration of the information processing apparatus 150. Each of these functions is realized by the CPU 250 executing a predetermined program.

A communication negotiation unit 301 executes negotiation for establishing a communication connection with the data processing apparatus 100. An application selection unit 302 selects the application program that will serve as a preview target.

A page number acquisition unit 303 acquires, from among the application data opened by the application program, the page number of the page that is opened by the application program. Depending on the type of application program, the application data may be a document, a table, or a diagram.

A sending unit 304 sends the application data that is opened by the application program and the page number of the page that is opened by the application program to the data processing apparatus 100.

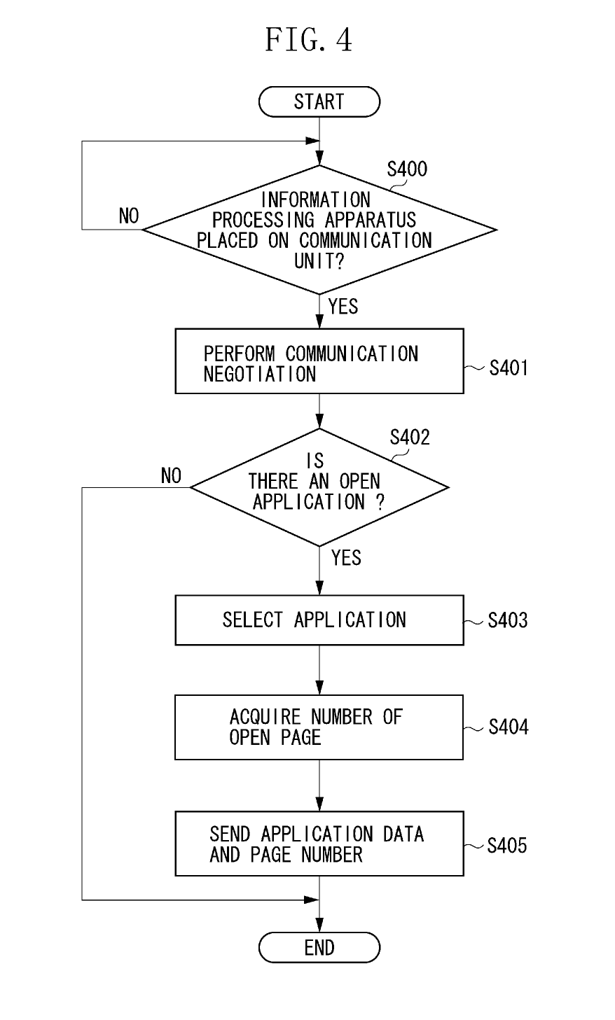

FIG. 4 is a flowchart illustrating information processing executed by the information processing apparatus 150. Especially, FIG. 4 relates to the selection of the application program and acquisition of the page number that is opened by that application program. This information processing is executed by the CPU 250 executing a predetermined program.

In step S400, the information processing apparatus 150 determines whether the data processing apparatus 100 is placed on the communication unit 110. If it is determined that the data processing apparatus 100 is placed on the communication unit 110 (YES in step S400), the processing proceeds to step S401. In step S401, the information processing apparatus 150 performs negotiation for establishing a communication connection with the data processing apparatus 100. This corresponds to the operation performed by the communication negotiation unit 301.

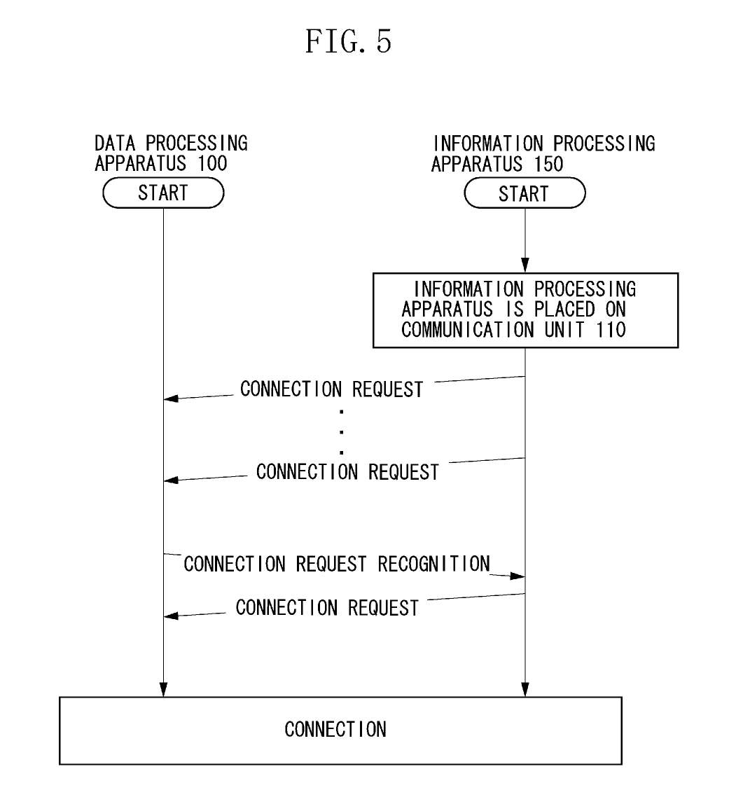

FIG. 5 is a sequence diagram illustrating negotiation for establishing a communication connection by wireless communication between the information processing apparatus 150 and the data processing apparatus 100.

When the information processing apparatus 150 is placed on the communication unit 110, the information processing apparatus 150 sends a connection request to the data processing apparatus 100. The sending of a connection request is repeated until there is a response from the data processing apparatus 100. When the data processing apparatus 100 receives a connection request from the information processing apparatus 150, the data processing apparatus 100 sends a response indicating recognition of the connection request (connection request acknowledgement) to the information processing apparatus 150.

When the information processing apparatus 150 receives a connection request acknowledgement from the data processing apparatus 100, the information processing apparatus 150 sends a response indicating connection recognition (connection acknowledgement) to the data processing apparatus 100. Consequently, a communication connection between the data processing apparatus 100 and the information processing apparatus 150 is established.

In step S402, the information processing apparatus 150 determines whether there is an application program that is open on the information processing apparatus 150. If it is determined that there is an open application program (YES in step S402), the processing proceeds to step S403.

In step S403, the information processing apparatus 150 selects one application program from among a plurality of application programs operating in the information processing apparatus 150, and sets the selected program as the preview target application program. This corresponds to the operation performed by the application selection unit 302.

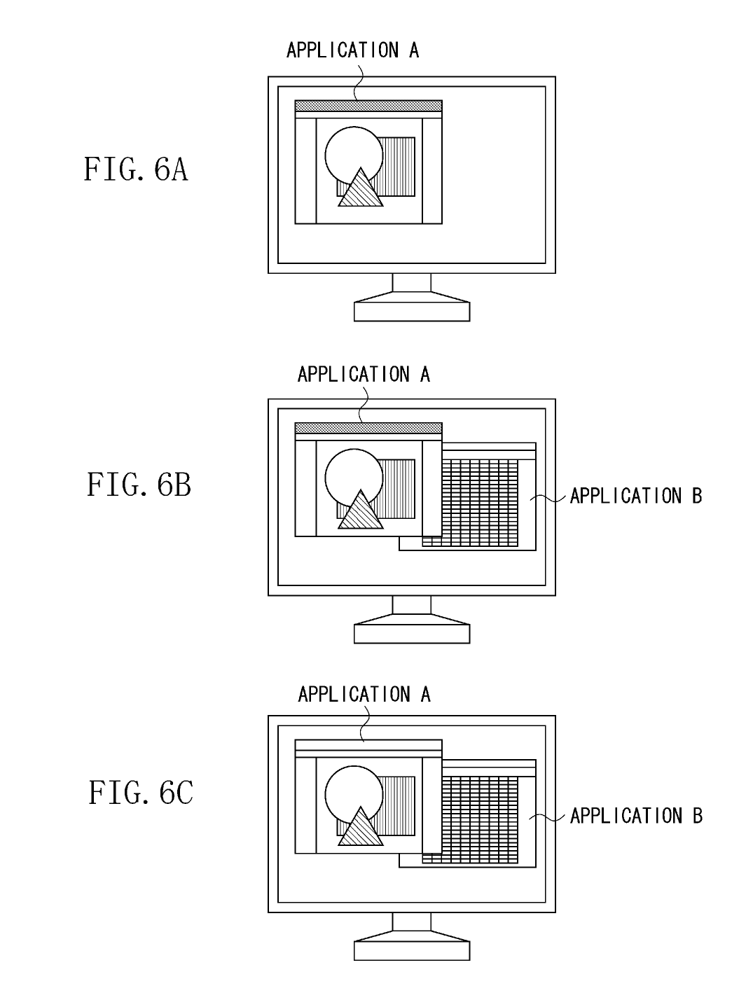

The method for selecting the application program will now be described referring to FIGS. 6A, 6B, and 6C. FIGS. 6A, 6B, and 6C illustrate an example of a screen displayed by the display unit 253 of the information processing apparatus 150.

In FIG. 6A, only one application program is open on the information processing apparatus 150, and a window of the application program A is selected by the user. The fact that the window of the application program A is selected is indicated by the fact that its window bar is darkened. In this case, the application selection unit 302 selects the application program A.

Even if the window of application program A is not selected, since only the application program A is opened, the application selection unit 302 selects the application program A.

FIGS. 6B and 6C illustrate a case in which a plurality of application programs are open on the information processing apparatus 150. FIG. 6B illustrates a case in which two application programs, the application program A and an application program B, are open, with the window of the application program A being selected.

In this case, the application selection unit 302 preferentially selects the application program that is selected by the user from among the plurality of open application programs. More specifically, the application selection unit 302 selects the application program A.

FIG. 6C illustrates a case in which two application programs, the application program A and the application program B, are open, with neither of the application programs being selected by the user. In this case, the application selection unit 302 preferentially selects the application program that was last selected by the user.

In FIG. 6C, the window of the application program A is in front of the window of the application program B. Therefore, the application selection unit 302 selects the application program A.

In step S404, the information processing apparatus 150 acquires the page number of the page that is currently opened by the application program from among the application data currently opened by the application program selected in step S403. This corresponds to the operation performed by the page number acquisition unit 303.

In step S405, the information processing apparatus 150 sends the application data that is currently being used by the application program selected in step S403 and the page number acquired in step S404 to the data processing apparatus 100. This corresponds to the operation performed by the sending unit 304.

A printer driver, which generates the image data for printing based on the application data, is usually installed on the information processing apparatus 150 side. However, in the present exemplary embodiment, the printer driver is also installed on the data processing apparatus 100 side.

Consequently, even when the user has not installed the printer driver on the information processing apparatus 150, processing such as printing is executed by the printer driver of the data processing apparatus 100 by placing the information processing apparatus 150 on the communication unit 110. Therefore, in the present exemplary embodiment, the application data is sent from the information processing apparatus 150 to the data processing apparatus 100 along with the page number of the page opened by the application program.

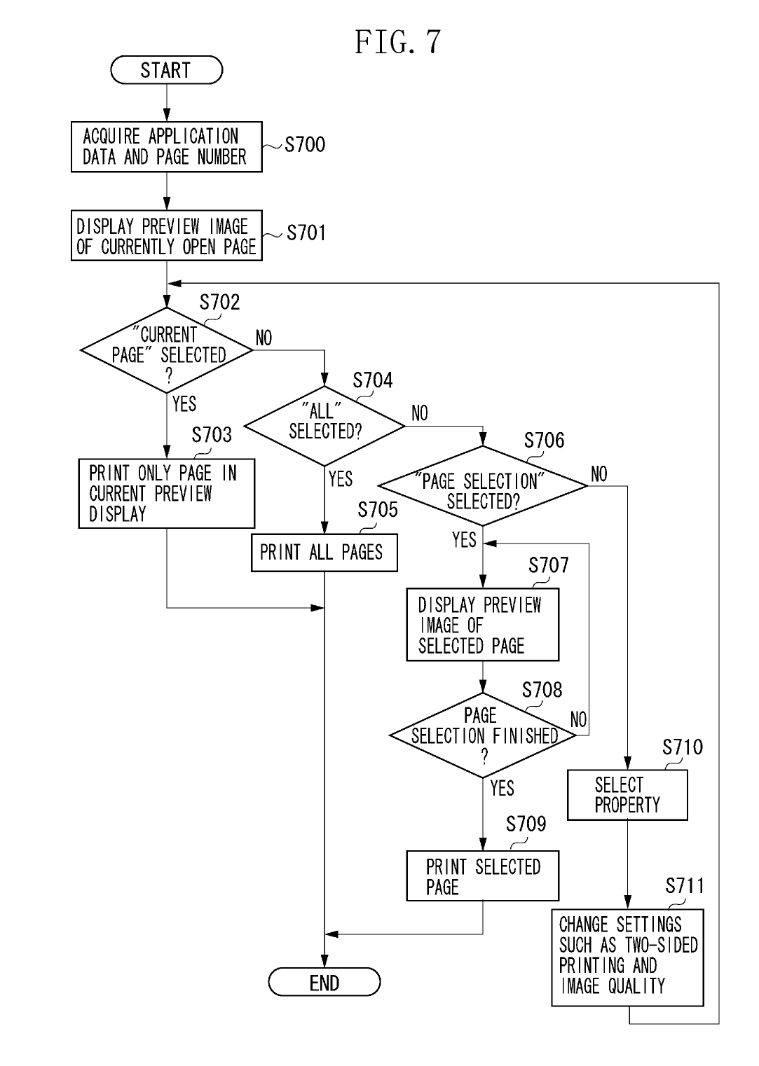

Next, the data processing executed by the data processing apparatus 100, which has received the application data and the page number, will be described. FIG. 7 is a flowchart illustrating data processing executed by the data processing apparatus 100. Especially, FIG. 7 relates to generation of the preview image and printing of the page specified by the user. This data processing is executed by the CPU 250 executing a predetermined program stored in the ROM 206.

In step S700, the data processing apparatus 100 receives the application data and the page number from the information processing apparatus 150.

In step S701, the data processing apparatus 100 generates preview image data in the preview image generation unit 204 based on the application data received in step S700, and displays a preview image showing the generated preview image data on the display unit 202. In this processing, the preview image generation unit 204, first, generates preview image data for the page of the received page number, and then generates preview image data of the pages before and after that page in order of closeness.

For example, if page 45 is currently opened, the preview image generation unit 204 generates preview image data in the order of page 45, page 44, page 46, page 43, page 47 and so on. This is because the chance that the currently opened page or vicinity thereof will be printed is high.

Then, the data processing apparatus 100 displays the preview image of the page corresponding to the page number received in step S700 on the display unit 202. Since a preview image of the same page that is opened by the application of the information processing apparatus 150 is displayed on the display unit 202, the user can easily confirm whether the preview image data is the desired data.

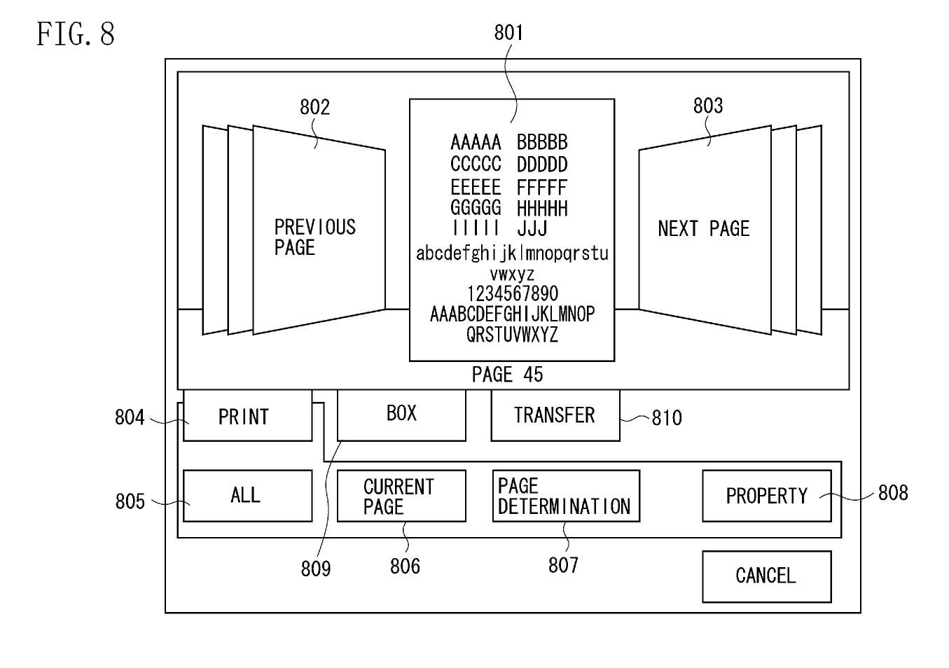

FIG. 8 illustrates an example of the preview image displayed on the display unit 202. A preview image 801 of the currently opened page is displayed in the middle. A preview image 802 of the previous page and a preview image 803 of the next page are respectively displayed cover flow-like on the left and right of the preview image 801. The page number is also displayed below the preview image 801. In FIG. 8, the setting unit 201 is configured from tabs such as a print key 804, a box key 805, and a transfer key 810.

When the user presses the box key 809, the data processing apparatus 100 stores application data received from the information processing apparatus 150 in a storage unit such as a HDD. When the user presses the transfer key 810, the data processing apparatus 100 transfers the application data to a predetermined file server and the like by using file transfer protocol (FTP).

When the user presses the print key 804, the data processing apparatus 100 displays an “all” key 805, a “current page” key 806, a “page selection” key 807, and a property key 808 on the display unit 202.

For the processing from step S702 and subsequent steps, the description will be based on the assumption that the print key 804 is pressed.

In step S702, the data processing apparatus 100 determines whether the “current page” key 806 is pressed. If it is determined that the “current page” key 806 is pressed (YES in step S702), the processing proceeds to step S703.

In step S703, the data processing apparatus 100 prints only the page displayed by the preview image in the middle of the display unit 202. More specifically, the image processing unit 205 performs image processing for printing on the portion of the relevant page from among the application data, and the printing unit 208 prints an image based on the thus-generated image data.

When the “current page” key 806 is pressed, if the generation of preview images for all of the pages is not yet finished, the preview image generation unit 204 does not have to generate preview image data for the subsequent preview images.

In step S704, the data processing apparatus 100 determines whether the “all” key 805 is pressed. If it is determined that the “all” key 805 is pressed (YES in step S704), the processing proceeds to step S705. In step S705, the data processing apparatus 100 prints all of the pages. The image processing unit 205 performs image processing for printing all the pages of the application data, and the printing unit 208 prints an image based on the thus-generated image data.

When the “all” key 805 is pressed, even if the generation of preview images for all of the pages is not yet finished, the preview image generation unit 204 does not have to generate preview image data for the subsequent preview images.

In step S706, the data processing apparatus 100 determines whether the “page selection” key 807 is pressed. If it is determined that the “page selection” key 807 was pressed (YES in step S706), the processing proceeds to step S707.

In step S707, the data processing apparatus 100 displays an image for specifying a page on the display unit 202, and also displays a preview image of the page specified by the user on the display unit 202.

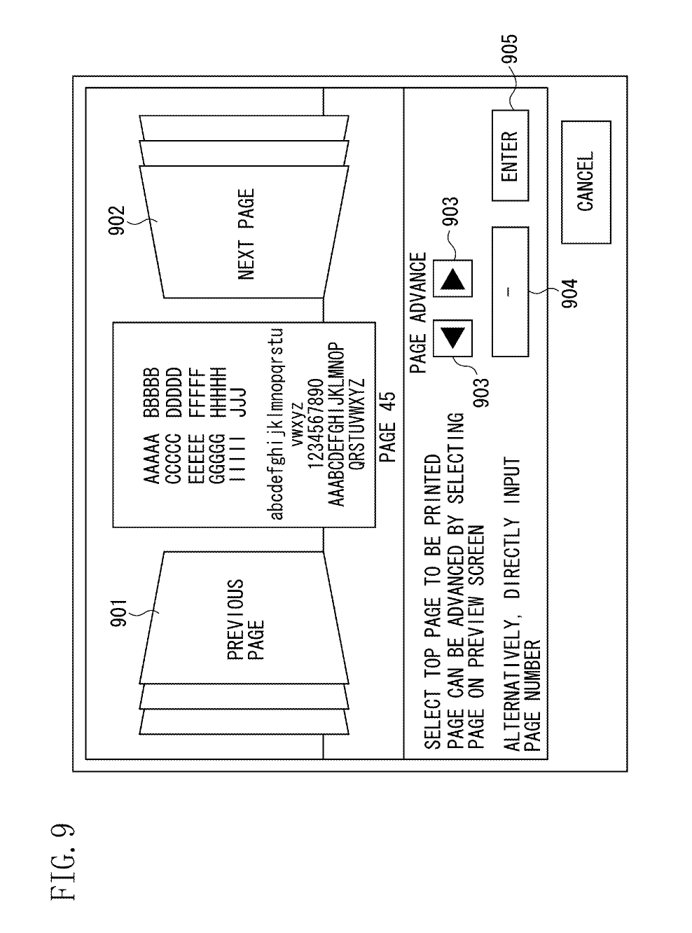

FIG. 9 illustrates an example of a screen for specifying a page. In the example illustrated in FIG. 9, the user can specify the page he/she wishes to print by touching the touch panel on the display unit 202. For example, when the CPU 200 detects that the user has touched a portion corresponding to a region 901, the CPU 200 displays the preview image of the previous page on the display unit 202.

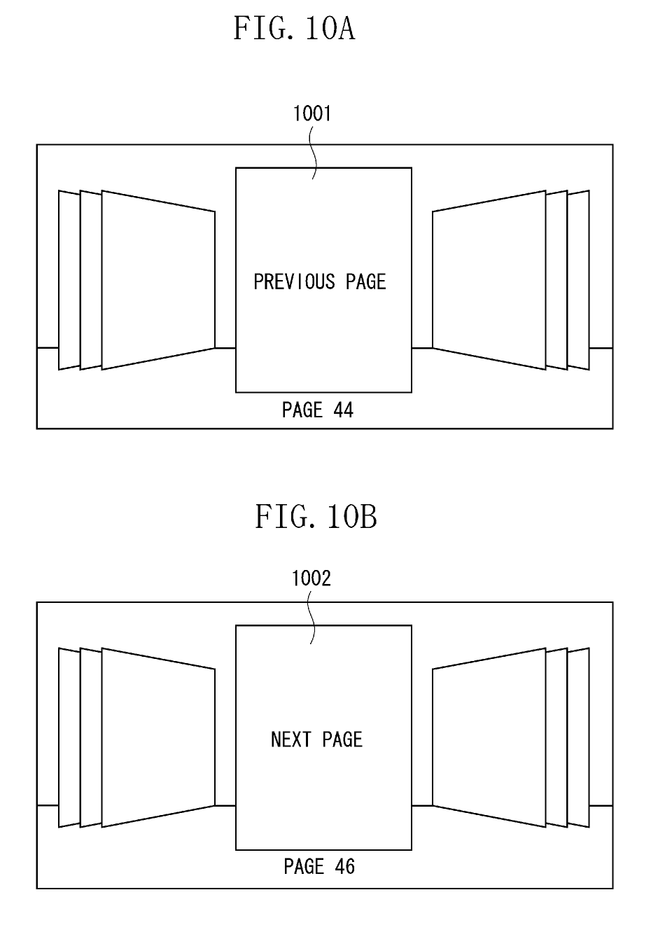

FIG. 10A illustrates a preview image 1001 of the previous page, page 44. The page number is also displayed below the preview image 1001. Since the preview image generation unit 204 generates the preview image data from the pages close to the page number received from the information processing apparatus 150, the preview images of the previous and following pages can be displayed relatively quickly.

On the other hand, when the CPU 200 detects that the user has touched a portion corresponding to region 902, the CPU 200 displays the preview image of the next page on the display unit 202. FIG. 10B illustrates a preview image 1002 of the next page, page 46. The page number is also displayed below the preview image 1002. In addition, the user may also advance or go back from that page by pressing a key 903.

Once the user determines the top page, he/she presses the “enter” key 905. Next, the data processing apparatus 100 displays an image for specifying the final page on the display unit 202.

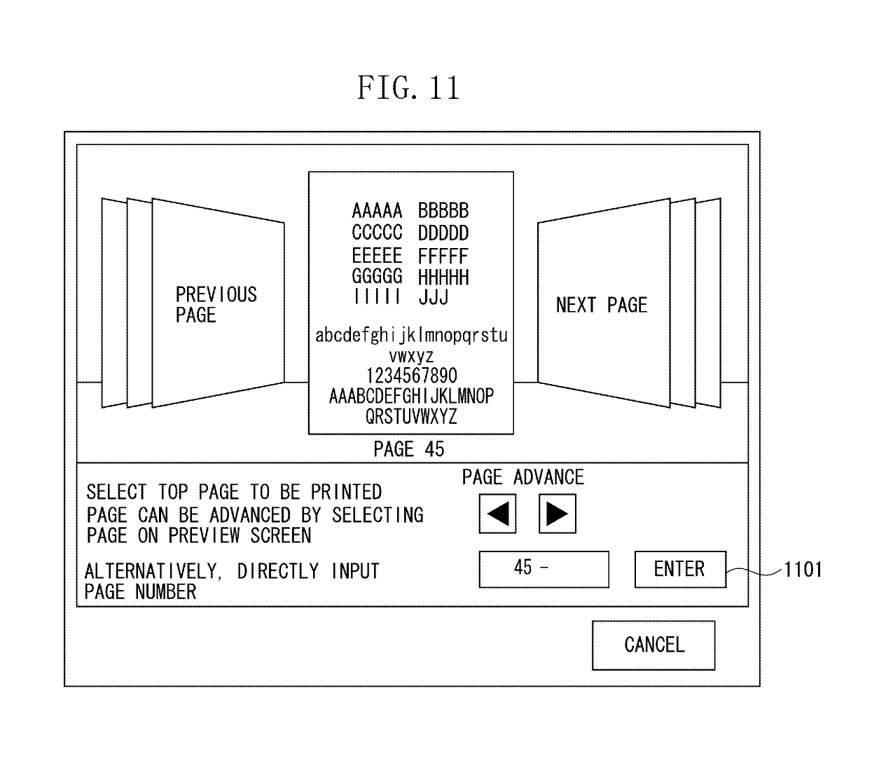

FIG. 11 illustrates an example of a screen for specifying the final page. Here, the top page is page 45. The user specifies the final page by operating the touch panel.

In step S708, the data processing apparatus 100 determines whether an “enter” key 1101 is pressed. If it is determined that the “enter” key 1101 is pressed (YES in step S708), the processing proceeds to step S709.

In step S709, the data processing apparatus 100 prints the page specified by the user. The image processing unit 205 performs image processing for printing on the portion of the page specified by the user from among the application data, and the printing unit 208 prints an image based on the thus-generated image data.

If the user utilizes a printer driver, to confirm the page that he/she wishes to print, conventionally it has been necessary to temporarily close the printer driver screen, and again confirm the page on the application program screen. Based on the above-described data processing, the user can specify the page he/she wishes to print while confirming the preview image on the display unit 202 of the data processing apparatus 100.

In FIG. 9, the user can specify a page without confirming the preview image, by directly specifying the page number with an input box 904. However, in this case, the user needs to know in advance the page number that he/she wishes to print.

Further, if the user specifies a page that is very far away from the page displayed by the preview image, the preview image generation unit 204 may not yet be able to generate the preview image data of that specified page. In such a case, first, the preview image generation unit 204 generates the preview image data of the specified page, and then returns to the order that had been generated until that point, and generates the preview image data for the subsequent pages.

In step S710, the data processing apparatus 100 determines that the property key 808 has been pressed. Then, in step S711, the data processing apparatus 100 displays a setting screen for the user to specify two-sided printing and select the image quality. The user then specifies the desired print setting.

Although the description of the processing from step S702 and the subsequent steps are performed based on the assumption that the print key 804 has been pressed, similar processing is performed if the transfer key 810 is pressed. In this case, while displaying on the display unit 202 the preview image of the page desired by the user, the data processing apparatus 100 stores the data corresponding to the page desired by the user in a storage unit such as a HDD, or transfers the data to a predetermined file server and the like by file transfer protocol (FTP).

In FIG. 7, although the data processing apparatus 100 displays the preview image on the display unit 202, the page corresponding to the received page number may be printed without the preview image being displayed.

In this case, the data processing apparatus 100 extracts the data corresponding to the page with the received page number from the application data, performs image processing for printing on the extracted data, and prints an image based on the thus-generated image data.

In FIG. 4, the information processing apparatus 150 sends the application data and the page number to the data processing apparatus 100. However, the application data of the portion corresponding to the page number may be sent to the data processing apparatus 100 without sending the page number to the data processing apparatus 100.

In such a case, the information processing apparatus 150 extracts the portion corresponding to the page number acquired in step S404 from the application data currently being used by the application selected in step S403, and sends the extracted data to the data processing apparatus 100. Consequently, the data processing apparatus 100 can display a preview image corresponding to only the currently opened page, and print only the currently opened page.

Thus, as described above, the user can intuitively perform processing, such as printing, relating to an application program open on the information processing apparatus 150 just by placing the information processing apparatus 150 on the communication unit 110. At this time, by confirming the preview image, the user can confirm whether the preview image data is the desired application data. Further, the user can confirm a preview image of each page while advancing through the pages, and specify the page that he/she wishes to perform printing or other such processing.

According to the present invention, an image indicated by data can be displayed by a display unit of a data processing apparatus so that the user can easily confirm whether the data that is about to be processed by the data processing apparatus is the desired data.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-284566 filed Dec. 15, 2009, which is hereby incorporated by reference herein in its entirety.

What is claimed is:

1. A data processing system, comprising:
an information processing apparatus,
wherein the information processing apparatus includes a sending unit configured to send data of an application program running on the information processing apparatus, and a page number of a page that is opened by the application program to the data processing apparatus; and
a data processing apparatus,
wherein the data processing apparatus includes,
a receiving unit configured to receive from the information processing apparatus the data of the application program and the page number of the page that is opened by the application program,
a display unit configured to display an image of a page corresponding to the page number received by the receiving unit from among the data received by the receiving unit, and
a data processing unit configured to, after the image is displayed by the display unit, process data received by the receiving unit.

2. The data processing system according to claim 1, wherein the data processing unit is configured to print data received by the receiving unit.

3. The data processing system according to claim 1, wherein
the information processing apparatus further comprises a selection unit configured to select an application program from among one or a plurality of application programs running on the information processing apparatus, and wherein
the sending unit is configured to send data of the application program selected by the selection unit.

4. The data processing system according to claim 3, wherein, in a case where there is only one application program running on the information processing apparatus, the selection unit is configured to select the application program.

5. The data processing system according to claim 3, wherein, from among the one or a plurality of application programs running on the information processing apparatus, the selection unit is configured to select an application program whose application program window is selected by a user.

6. The data processing system according to claim 5, wherein, from among the one or the plurality of application programs running on the information processing apparatus, in a case where none of the application program windows is selected by the user, the selection unit is configured to select the application program that has been selected last by the user.

7. The data processing system according to claim 1, further comprising a generation unit configured to generate image data of an image displayed by the display unit, wherein the generation unit is configured to generate image data of a page corresponding to the page number received by the receiving unit, and then generate image data of pages before and after the page number received by the receiving unit in order of closeness therefrom.

8. The data processing system according to claim 1, further comprising a setting unit configured to set a page of the image displayed by the display unit, wherein the display unit is configured to display an image corresponding to the page set by the setting unit.

9. The data processing system according to claim 8, wherein the setting unit includes a touch panel.

10. The data processing system according to claim 9, wherein the display unit and the setting unit are integrated, so that the user can set a page while viewing an image.

11. The data processing system according to claim 8, further comprising a generation unit configured to generate image data of an image displayed by the display unit, wherein the generation unit is configured to, in a case where image data of the image corresponding to the page set by the setting unit has not been generated, preferentially generate image data of the image corresponding to the page set by the setting unit.

12. A data processing apparatus capable of communicating with an information processing apparatus, comprising:
a receiving unit configured to receive data of an application program that is running on the information processing apparatus, and a page number of a page that is opened by the application program from the information processing apparatus;
a display unit configured to display an image of a page corresponding to the page number received by the receiving unit from among the data received by the receiving unit; and
a data processing unit configured to, after the image is displayed by the display unit, process data received by the receiving unit.

13. A data processing method executed by a data processing apparatus capable of communicating with an information processing apparatus, the method comprising:
receiving data of an application program that is running on the information processing apparatus, and a page number of a page that is opened by the application program, from the information processing apparatus;
displaying an image of a page corresponding to the received page number from among the received data, on a display unit of the data processing apparatus; and
processing the received data after the image is displayed by the display unit.

14. A computer-readable storage medium storing a program for causing a computer to execute a data processing method, the data processing method comprising:
receiving data of an application program that is running on the information processing apparatus, and a page number of a page that is opened by the application program, from the information processing apparatus;
displaying an image of a page corresponding to the received page number from among the received data, on a display unit of the data processing apparatus; and
processing the received data after the image is displayed by the display unit.

15. A data processing system, comprising an information processing apparatus and a data processing apparatus, wherein
the information processing apparatus comprises a sending unit configured to send data of an application program running on the information processing apparatus, and a page number of a page that is opened by the application program, to the data processing apparatus, and wherein
the data processing apparatus comprises:
a receiving unit configured to receive the data of an application program and the page number of a page that is opened by the application program, from the information processing apparatus; and
a data processing unit configured to process data corresponding to the page number received by the receiving unit from among the data received by the receiving unit.

16. An information processing apparatus capable of communicating with a data processing apparatus, comprising:
a first specifying unit configured to specify an application program running on the information processing apparatus;
a second specifying unit configured to specify a page that is opened by the application program from among data of the application program running on the information processing apparatus; and
a sending unit configured to send to the data processing apparatus data corresponding to the page specified by the second specifying unit from among the data of the application program specified by the first specifying unit.

17. An information processing method executed by an information processing apparatus capable of communicating with a data processing apparatus, the method comprising:
specifying an application program running on the information processing apparatus;
specifying a page that is opened by the application program from among data of the application program running on the information processing apparatus; and
sending to the data processing apparatus data corresponding to the specified page from among the data of the specified application program.

18. A computer-readable storage medium storing a program for causing a computer to execute an information processing method, the information processing method comprising:
specifying an application program running on the information processing apparatus;
specifying a page that is opened by the application program from among data of the application program running on the information processing apparatus; and
sending to a data processing apparatus data corresponding to the specified page from among the data of the specified application program.
